(19) United States
(12) Patent Application Publication
(10) Pub. No.: US 2012/0113511 A1
(43) Pub. Date: May 10, 2012

(54) Display Device for Generating Three Dimensional Images

(75) Inventors: Yi-Chih Chen, Hsin-Chu (TW); Ching-Ming Wei, Hsin-Chu (TW)

(73) Assignee: AU OPTRONICS CORPORATION, Hsin-Chu (TW)

(21) Appl. No.: 13/283,725

(22) Filed: Oct. 28, 2011

(30) Foreign Application Priority Data
Nov. 8, 2010 (TW) 099138373

(51) Int. Cl. G02B 27/22; G02B 27/12

(52) U.S. Cl. 359/463; 359/619

(57) ABSTRACT

A display device for generating three-dimensional images includes a display panel, a reinforcing plate, and a light-splitting layer. The reinforcing plate is attached to at least one surface of the display panel to improve the resistance to the flexing and deformation of the display panel. If the reinforcing plate is attached to a display surface of the display panel, the reinforcing plate needs to be light transmissible. The rigidity of the reinforcing plate should be greater than the rigidity of the display panel so that the attached reinforcing plate is able to support and prevent flexing of the display panel. The light-splitting layer is disposed corresponding to the display surface and distant from the display panel by a gap. An air layer is formed between the light-splitting layer and the display surface.

### BACKGROUND OF THE INVENTION

1. Field of the Invention

The present invention generally relates to a display device. Particularly, the present invention relates to a display device for generating three-dimensional (3-D) images.

2. Description of the Related Art

Along with the advance in technology, three-dimensional image display techniques are gradually becoming more valued. In terms of the technologies of the current mainstream three-dimensional image displays, there are two predominant display theories. The first display theory involves separately displaying with time lapse a left-eye image and a right-eye image on the display device. Users would be required to wear specially made three-dimensional glasses so that a three-dimensional visual effect may be generated and observed from the opening and closing of the left and right lens of the glasses, synchronous to the display image. The second display theory involves controlling, within a specific viewing range from the display device, the display device's generation of different distinguishable interval images. In other words, when users are within the viewing range of the display device, their left and right eyes will individually observe different interval generated images, forming into a three-dimensional image.

In terms of the second display theory mentioned above, the convenience provided to users in viewing three-dimensional visual effects without wearing three-dimensional glasses is slowly but surely being valued on the market. FIG. 1 illustrates a display device utilizing the conventional second display theory mentioned above. As shown in FIG. 1, the display device includes a display panel 10, a backlight module 20, a protective cover 70, and a light-splitting lens 50. The backlight module 20 is disposed below the display panel 10 and radiates light into the display panel 10. The display panel 10 controls the twist of the liquid crystals to adjust the light radiating from a display surface 17 of the display panel 10 to form an image. The protective cover 70 is disposed on top of the display panel 70 and is distant from the display panel 10 by an air layer 80. The light-splitting lens 50 is disposed on an outer side of the protective cover 70 with its prisms protruding outwards. Image light from the display panel 10 undergoes light-splitting by the light-splitting lens 50 so that different image shifts may be generated and observed within a default viewing range position. When viewers are at the default viewing range position, their left and right eyes will separately receive different shifted images to produce a three-dimensional visual effect.

In the conventional design shown in FIG. 1, the protective cover 70 and the light-splitting lens 50 are composed with the system housing body 90. Therefore, in these related designs, the gap between the light-splitting lens 50 and the display panel 10 is not easily maintainable. In addition, since the thickness of the display panel 10 is smaller and the display panel 10 is relatively softer, particularly when the dimension of the display panel 10 is relatively greater, the display panel 10 is susceptible to flexing with respect to the light-splitting lens 50. The gap between the light-splitting lens and the display panel 10 directly influences the light-splitting effect of the light-splitting lens 50 and the image generated at the viewing position. Consequently, the deformation of the display panel 10 results in poor three-dimensional visual effect. Moreover, the light-splitting lens 50 and the prisms thereon are exposed, susceptible to damage by external force.

### SUMMARY OF THE INVENTION

It is an object of the present invention to provide a display device capable of outputting relatively more stable three-dimensional visual effects.

It is another object of the present invention to provide a display device providing better protection to the light-splitting layer included therein.

The display device includes a display panel, a reinforcing plate, and a light-splitting layer. The display panel has a display surface and a bottom surface, wherein the display surface and the bottom surface are opposite to each other. The reinforcing plate is attached to a surface of the display panel to increase the resistance to flexing and deformation of the display panel. The reinforcing plate can be selectively attached on the display surface of the display panel, wherein the reinforcing plate would need to be light-transmissible to allow image light generated from the display surface to pass through. The reinforcing plate may be attached on the bottom surface of the display panel or may be evenly disposed on the display surface and the bottom surface. The rigidity of the reinforcing plate is greater than the rigidity of the display panel, and therefore the reinforcing plate correspondingly has relatively higher resistance strength to flexing and deforming. After attaching the reinforcing plate to the surface of the display panel, the reinforcing plate can support the entire flat surface of the display panel to maintain the shape of the display panel in order to avoid curving thereof.

The light-splitting layer is disposed corresponding to the display surface and is distant from the display panel by a gap, wherein the gap forms an air layer. The image light generated from the display surface radiates outward through the light-splitting layer. The light-splitting layer has a plurality of columnar lens formed thereon in order to light-split the image light generated from the display surface. The display device additionally includes a transparent protective plate disposed corresponding to the display surface. The light-splitting layer is attached to a surface of the transparent protective plate facing the display surface.

### BRIEF DESCRIPTION OF THE DRAWINGS

FIG. 1 is a cross-sectional view of the conventional display device;

FIG. 2 is a cross-sectional view of an embodiment of the display device of the present invention;

FIG. 3 is a cross-sectional view of another embodiment of the display device of the present invention;

FIG. 4 is a cross-sectional view of another embodiment of the display device of the present invention;

FIG. 5 is a cross-sectional view of another embodiment of the display device of the present invention; and

FIG. 6 is a top view of the embodiment of FIG. 4.

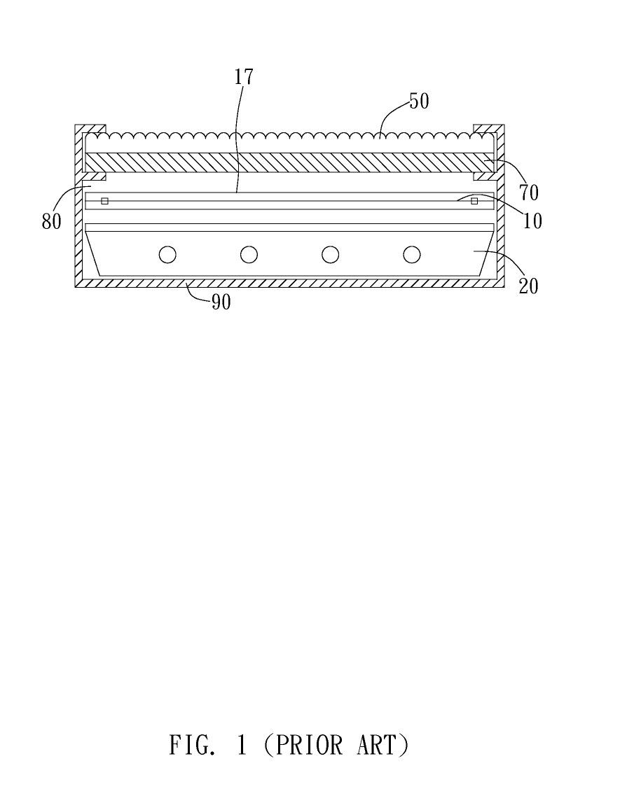

### DETAILED DESCRIPTION OF THE PREFERRED EMBODIMENT

The present invention involves a display device to provide three-dimensional visual effects for users. In a preferred embodiment, the display device is a liquid crystal display device having a backlight module. However, in other embodiments, the display device may be a self-luminous type display device or a reflective type display device utilizing the environmental light.

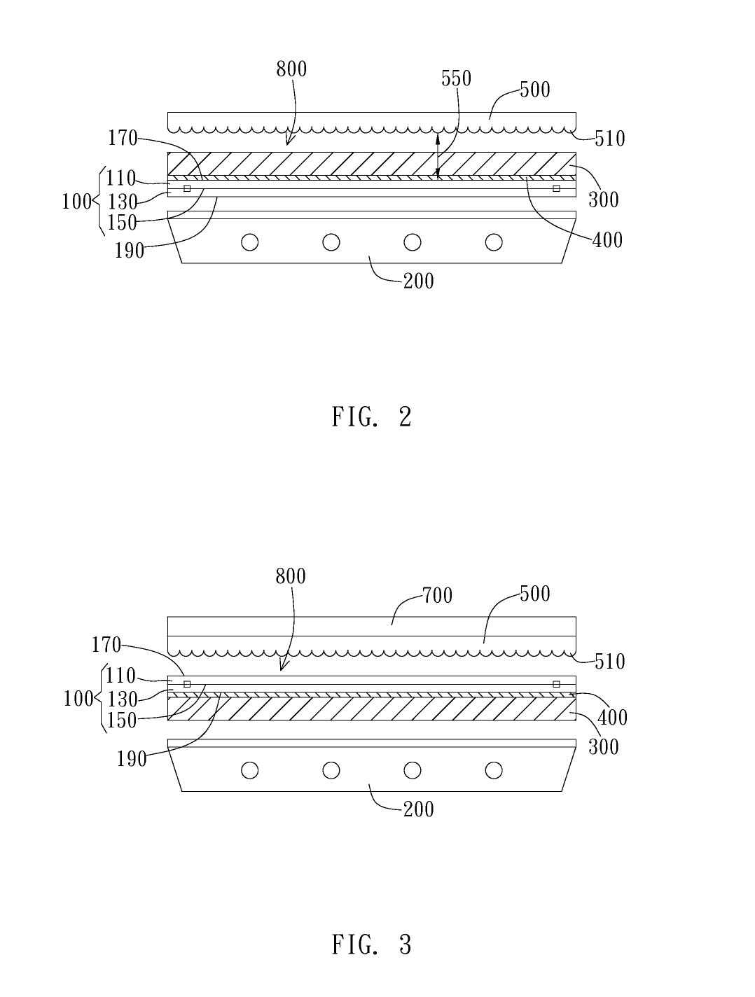

In the embodiment shown in FIG. 2, the display device includes a display panel 100, a reinforcing plate 300, and a light-splitting layer 500. In the present embodiment, the display panel 100 is preferably a liquid crystal display panel composed of a top substrate 110 and a bottom substrate 130. The bottom substrate 130 preferably has a thin film transistor thereon, while the liquid crystal layer 150 is formed between the top substrate 110 and the bottom substrate 130. The thin film transistors may change the twists of the liquid crystals in accordance to different pixel coordinates in order to control the brightness of each pixel. By complementing on top of each pixel coordinate a different colored color filter, light of different colors and brightness may be emanated to compose an image. In addition, in the present embodiment, the display panel 100 preferably coordinates with a backlight module 200, receiving light generated from the backlight module 200. The twist of the liquid crystal layer 150 controls the amount of light passing through the various pixels in order to control the brightness at each pixel.

As shown in FIG. 2, the display panel 100 has a display surface 170 and a bottom surface 190, wherein the bottom surface 190 faces the backlight module 200 while the display surface 170 faces away from the bottom surface 190. Light generated from the backlight module 200 enters into the display panel 100 from the bottom surface 190 and forms an image on the display surface 170 under the control of the liquid crystal layer 150. However, in other embodiments, the display panel 100 may be a self-luminous type display panel such as a light emitting diode (LED) panel, wherein the backlight module 200 would be unnecessary.

The reinforcing plate 300 is preferably a plate with light-transmissible properties, wherein the light-transmission rate is preferably greater than 97%. In terms of the material, the reinforcing plate 300 is preferably manufactured from glass or plastics with relatively higher rigidity, such as polycarbonate (PC) or polymethylmethacrylate (PMMA). The reinforcing plate 300 is attached on a surface of the display panel 100 to increase the resistance of the display panel 100 to flexing and deforming. In the embodiment shown in FIG. 2, the reinforcing plate 300 is attached on the display surface 170 of the display panel 100, wherein the reinforcing plate 300 needs to be light-transmissible in this case to allow image light generated from the display surface 170 to pass through. However, in other embodiments, the reinforcing plate 300 may be attached on the bottom surface 190 of the display panel 100 (as shown in FIG. 3) or disposed on both the display surface 170 and the bottom surface 190 (not shown).

The rigidity of the reinforcing plate 300 is greater than the rigidity of the display panel 100, and therefore the reinforcing plate 300 has better resistance to flexing and deforming relative to the display panel 100. The rigidity of the display panel 100 preferably refers to the rigidity of the entire assembled body of the display panel 100 with the top substrate 100 and the bottom substrate 130. The reinforcing plate 300 supports the entire flat surface of the display panel 100 after being attached thereof to maintain and prevent the display panel 100 from flexing or deforming. In order to allow the reinforcing plate 300 to have relatively higher rigidity, materials with higher hardness and rigidity may be selected for the manufacturing of the reinforcing plate 300. In addition, the objective of raising the rigidity may be accomplished by increasing the thickness of the reinforcing plate 300. For instance, the thickness of the reinforcing plate 300 may be set to be greater than the thickness of the display panel 100. Furthermore, in consideration of the optical properties and performance, the difference in light refractive index of the reinforcing plate 300 with the display panel 100 or with the top substrate 110 is preferably small.

In a preferred embodiment, an optical adhesive layer 400 is disposed between the reinforcing plate 300 and the display panel 100 to allow the reinforcing plate 300 to attach onto the surface of the display panel 100. The optical adhesive layer 400 may be distributed between the reinforcing plate 300 and the display panel 100 by coating methods. Sheets of optical adhesive layer 400 may be adopted to directly adhere onto the display panel 100, wherein thereafter the combination may be assembled with the reinforcing plate 300. In addition, the optical adhesive layer 400 may be cured through light curing, heat curing, drying, or any other curing methods to maintain the support strength of the reinforcing plate 300 on the display panel 100.

As shown in FIG. 2, the light-splitting layer 500 is disposed facing the display surface 170 and distant from the display panel 100 by a gap 550. Image light generated from the display surface 170 radiates outward through the light-splitting layer 500. The light-splitting layer 500 has a plurality of columnar lens 510 formed thereon to light-split the image light generated from the display surface 170. The columnar lens 510 is preferably of circular or oval columnar lens protruding towards the display surface 170. However, in other embodiments, the columnar lens 510 may also be of other forms of lens, such as concave lens or other cross-sectional shaped lens. In addition, the plurality of columnar lens 510 is preferably distributed parallel to each other on the light-splitting layer 500. The columnar lens 510 is preferably formed on the display panel 100 through thermal pressuring methods. However, in other embodiments, other methods such as printing, engraving, casting may also be utilized in the manufacturing process. Through the disposition of the light-splitting layer 500, the columnar lens 510 is able to light split the light of each pixel in the light-splitting lens 510 so that within a particular viewable range from the display device, separated different images can be generated in a controlled manner. In other words, when users are within the viewing range of the display device, their left and right eyes will observe different images resulting from the splitting, allowing the users to see a three-dimensional visual effect.

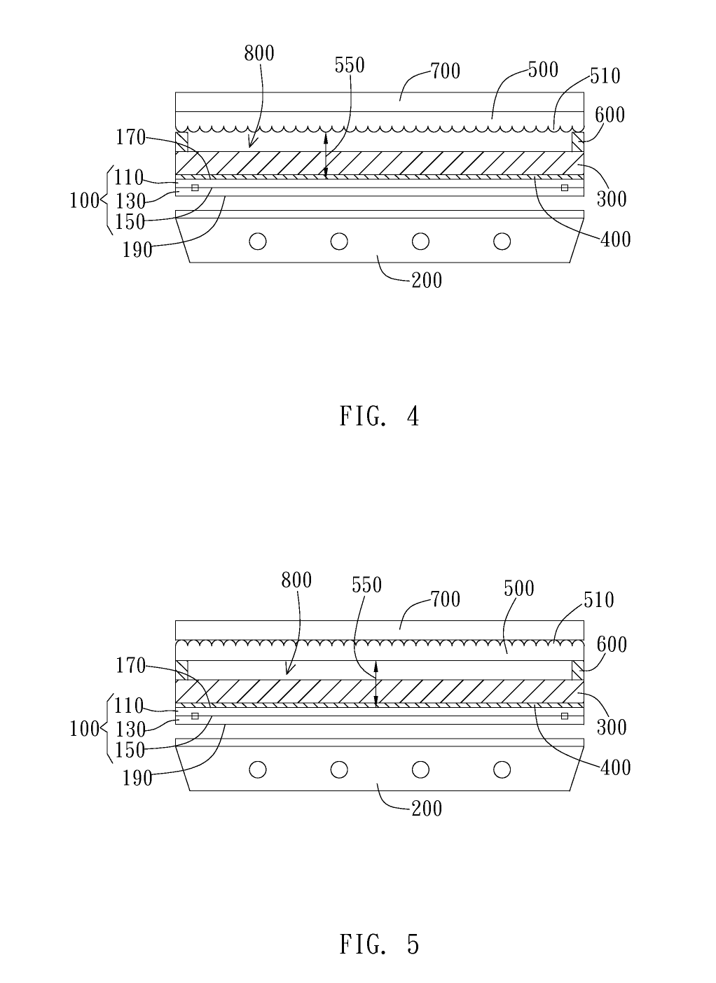

As shown in an embodiment in FIG. 4, the display device further includes a transparent protective plate 700 disposed corresponding to the display surface 170 and is distant from the display panel 100 by a gap 550. The light-splitting layer 500 is attached to a surface of the transparent protective plate 700 facing the display surface 170 with the columnar lens 510 protruding towards the display surface 170. However, in other embodiments such as the one shown in FIG. 5, the columnar lens 510 may protrude toward the transparent protective plate 700. The transparent protective plate 700 preferably has hardness greater than that of the light-splitting layer 500 to provide protection on top of the light-splitting layer 500 in order to prevent damages (such as scratches and other related damages) to the light-splitting layer 500 from external forces. In addition, the transparent protective plate 700 may also provide a positioning and supporting effect for the light-splitting layer 500 so that the relative positions between the light-splitting layer 500 and the display surface 170 may be stabilized. After undergoing light splitting in the light-splitting layer 500, the image light generated by the display surface 170 pass through the transparent protective plate 700 and radiates outwards.

As shown in FIGS. 4 and 5, an air layer 800 is formed between the light-splitting layer 500 and the display surface 170. In the present embodiment, since the reinforcing plate 300 is attached onto the display surface 170, therefore the air layer 800 is not directly in contact with the display surface 170 but rather is parallel to the display surface 170 with the reinforcing plate 300 interposed there between. The air layer 800 and the reinforcing plate 300 are preferably parallel to each other and together completely fill the gap 550 between the light-splitting layer 500 and the display surface 170. In a preferred embodiment, the overall thickness of the reinforcing plate 300 and the air layer 800 is greater than the focal length of the columnar lens 510. In this embodiment, since the refractive index of the reinforcing plate 300 is greater than the refractive index of the air layer 800, the image light generated by the display surface 170 can be effectively light split by the light-splitting layer 510 if the overall thickness of the reinforcing plate 300 and the air layer 800 is greater than the focal length of the columnar lens 510. In the preferred circumstance, the sum of the ratio of thickness to refractive index of the reinforcing plate 300 and the ratio of thickness to refractive index of the air layer 800 should be equal to or close to the focal length of the columnar lens 510.

In addition, in the preferred embodiment, the thickness ratio of the air layer 800 to the reinforcing plate 300 is between 0.22 and 0.89. In terms of a 55 inch display panel 100, when the radius of the curvature of the columnar lens 510 is 3.07 mm and the gap between each columnar lens 510 is between 1.0 mm and 1.1 mm, the thickness of the air layer 800 may be 2 mm while the thickness of the reinforcing plate 300 may be 4 mm. In addition, under the same conditions, the thickness of the air layer 800 may be between 2.0 mm and 2.1 mm while the thickness of the reinforcing plate 300 may be 3 mm. Moreover, when the radius of the curvature of the columnar lens 510 is 2 mm and its refractive index is 1.5, if the refractive index of the reinforcing plate 300 1.5, then the thickness of the air layer 800 may be designed to be 2.0 mm while the thickness of the reinforcing plate 300 may be 3 mm. In addition, under the same conditions, the thickness of the air layer 800 may be designed to be 1 mm while the thickness of the reinforcing plate 300 may be 4.5 mm. If glass is adopted as material for the reinforcing plate 300, the thickness would then be preferably no smaller than 4 mm.

In addition, in a preferred embodiment, the thickness of the air layer 800 at every point should be substantially the same. In the preferred conditions, the difference between the thickness of the air layer 800 at every point and the average thickness of the air layer 800 should be maintained to be within 0.5 mm. Through adjusting the material, rigidity, and thickness of the reinforcing plate 300 or transparent protective plate 700, or through disposing spacers and other such gapping components between the reinforcing plate 300 and the light-splitting layer 500, the thickness of the air layer 800 may be effectively controlled.

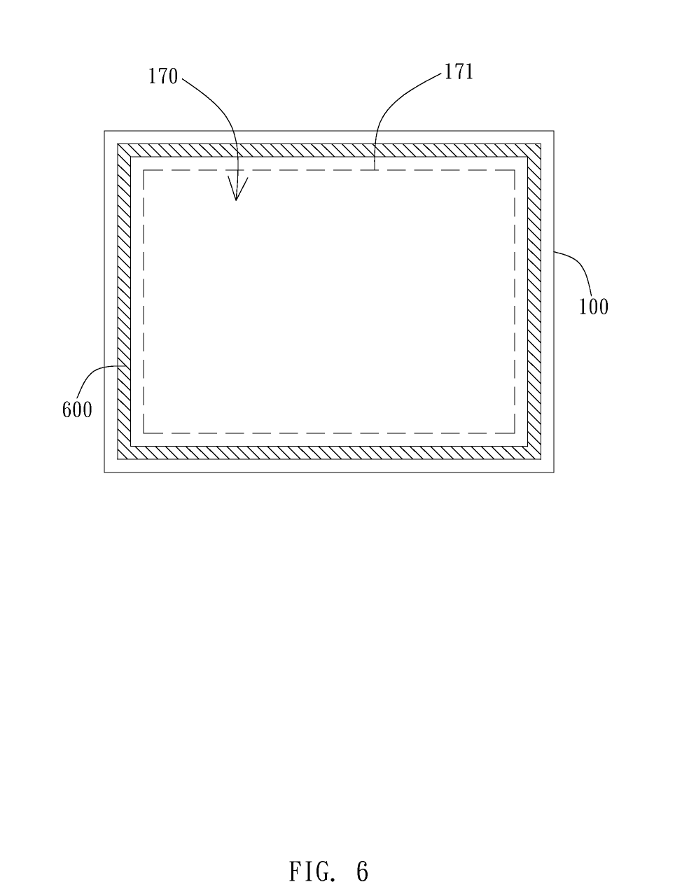

As shown in FIGS. 4 and 5, the transparent protective plate 700 and the light-splitting layer 500 are preferably designed to be one assembled module with the display panel 100 and the reinforcing plate 300. In the present embodiment, the reinforcing plate 300 is attached to the display surface 170 of the display panel 100, while the light-splitting layer 500 is attached to an inner surface of the transparent protective plate 700. A spacer 600 is disposed between the reinforcing plate 300 and the light-splitting layer 500 to connect the reinforcing plate 300 and the light-splitting layer 500 together. As shown in FIG. 6, the display surface 170 has an active area 171 for displaying images, wherein the projection of the spacer on the display surface 170 is preferably outside the active area 171 in order to lower the interference of the image formation. Through the present design, the transparent protective plate 700, the light-splitting layer 500, the display panel 100, and the reinforcing plate 300 may be assembled as a single module to increase the convenience during the assembling process. At the same time, the present design is also effective in maintaining the relative positions between the above mentioned components in order to improve the optical performance. The spacer 600 is preferably formed from rubber, silicone, or any other materials. The spacer 600 may be distributed along the active area 171 to form a frame structure. However, in other embodiments, the transparent protective plate 700 and the light-splitting layer 500 may be directly integrated into the system. For instance, the transparent protective plate 700 and the light-splitting layer 500 may be connected with the outer housing or other such related components, wherein the integrated design of the display panel 100 and the reinforcing plate 300 is not adopted.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A display device, comprising:
a display panel having a bottom surface and a display surface opposite to each other;
a reinforcing plate attached to at least one of the bottom surface and the display surface, wherein the rigidity of the reinforcing plate is greater than the rigidity of the display panel, and the reinforcing plate needs to be light transmissible if the reinforcing place is attached to the display surface;
a transparent protective plate disposed corresponding to the display surface and distant from the display panel by a gap; and
a light-splitting layer having a plurality of columnar lens, wherein the light-splitting layer is attached to a surface of the transparent protective plate facing the display surface;
wherein an air layer is formed between the light-splitting layer and the display surface.

2. The display device of claim 1, wherein the plurality of columnar lens of the light-splitting layer is disposed protruding toward the display surface.

3. The display device of claim 1, wherein the plurality of columnar lens of the light-splitting layer is disposed protruding toward the transparent protective plate.

4. The display device of claim 1, wherein the air layer is formed between the reinforcing plate and the light-splitting layer when the reinforcing plate is attached to the display surface, and the overall thickness of the reinforcing plate and the air layer is greater than the focal length of the columnar lens.

5. The display device of claim 4, wherein the ratio of the thickness of the air layer and the reinforcing plate is between 0.22 and 0.89.

6. The display device of claim 4, further comprising a spacer disposed between the reinforcing plate and the light-splitting layer, wherein the display surface has an active area and the projection of the spacer on the display surface is outside the active area.

7. The display device of claim 1, wherein the difference between the thickness of the air layer at any point of the air layer and the average thickness of the air layer is less than or equal to 0.5 mm.

8. The display device of claim 1, further comprising an optical adhesive layer disposed between the display panel and the reinforcing plate, wherein the optical adhesive layer secures the relative positions of the display panel and the reinforcing plate.

9. A display device, comprising:
a display surface having a bottom surface and a display surface opposite to each other;
a reinforcing plate attached to at least one of the bottom surface and the display surface, wherein the rigidity of the reinforcing plate is greater than the rigidity of the display panel, and the reinforcing plate needs to be light transmissible if the reinforcing plate is attached to the display surface; and
a light-splitting layer disposed corresponding to the display surface and distant from the display panel by a gap, wherein the light-splitting layer has a plurality of columnar lens disposed protruding toward the display surface;
wherein an air layer is formed between the light-splitting layer and the display surface.

10. The display device of claim 9, wherein the air layer is formed between the reinforcing plate and the light-splitting layer when the reinforcing plate is attached to the display surface, and the overall thickness of the reinforcing plate and the air layer is greater than the focal length of the columnar lens.

11. The display device of claim 10, wherein the ratio of the thickness of the air layer to the reinforcing plate is between 0.22 and 0.89.

12. The display device of claim 10, further comprising a spacer disposed between the reinforcing plate and the light-splitting layer, wherein the display surface has an active area and the projection of the spacer on the display surface is outside the active area.

13. The display device of claim 9, wherein the difference between the thickness of the air layer at any point of the air layer and the average thickness of the air layer is less than or equal to 0.5 mm.

14. The display device of claim 9, further comprising an optical adhesive layer disposed between the display panel and the reinforcing plate, wherein the optical adhesive layer secures the relative positions of the display panel and the reinforcing plate.
